(19) United States
(12) Patent Application Publication
(10) Pub. No.: US 2005/0225243 A1
(43) Pub. Date: Oct. 13, 2005

(54) Plasma display panel

(76) Inventors: Min-Sun Yoo, Suwon-si (KR); Jeong-Nam Kim, Suwon-si (KR); Tae-Ho Lee, Suwon-si (KR); Yon-Goo Park, Suwon-si (KR)

Correspondence Address: MCGUIREWOODS, LLP, 1750 TYSONS BLVD, SUITE 1800, MCLEAN, VA, 22102, US

(21) Appl. No.: 11/099,478

(22) Filed: Apr. 6, 2005

(30) Foreign Application Priority Data
Apr. 8, 2004 (KR) 10-2004-0024062

(51) Int. Cl. H01J 17/49

(52) U.S. Cl. 313/582

(57) ABSTRACT

A plasma display panel includes first and second substrates mounted opposing one another, address electrodes formed along a first direction on the second substrate, barrier ribs mounted between the first and second substrates and defining a plurality of discharge cells, phosphor layers formed respectively in the discharge cells, and first electrodes and second electrodes formed on the first substrate along a second direction perpendicular to the first direction. Each first electrode and second electrode includes a bus electrode formed along the second direction and a plurality of transparent electrodes formed extending from the bus electrode in a direction toward centers of the discharge cells. Pairs of the transparent electrodes oppose one another respectively in areas corresponding to the discharge cells, and the transparent electrodes comprise light-blocking members.

### CROSS REFERENCE TO RELATED APPLICATION

This application claims priority to and the benefit of Korean Patent Application No. 10-2004-0024062, filed on Apr. 8, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP that blocks reset light generated in un-selected discharge cells to thereby improve contrast while maintaining appropriate brightness.

2. Discussion of the Background

Generally, a PDP displays images through gas discharge. The PDP offers many advantages over other display configurations including brightness, contrast, minimal afterimages, wide viewing angle, and it may have a very large display area. Consequently, the PDP is quickly replacing the cathode ray tube for a wide range of applications. In the PDP, applying a direct or alternating current voltage to electrodes generates a gas discharge between them, thereby creating ultraviolet rays that excite phosphors to emit light.

Depending on subpixel arrangement, the PDP may be classified as a stripe-type PDP, which has red, green, and blue subpixels arranged in a stripe pattern, or a delta-type PDP, which has red, green, and blue subpixels arranged as triangular triplets.

U.S. Pat. No. 5,841,232 discloses a stripe-type PDP. In this PDP, scan electrodes and sustain electrodes may be formed on a front substrate to improve brightness and illumination efficiency. The scan and sustain electrodes may be metal electrodes, rather than a combination of metal and transparent electrodes. Barrier ribs and data electrodes are formed perpendicular to each other on a rear substrate. Although the PDP may improve illumination efficiency, a sufficient area of the scan electrodes and the sustain electrodes is not utilized to obtain a good aperture ratio, which may result in a loss of brightness. Further, if non-transparent data electrodes are formed on the rear substrate, although discharge illumination may increase, a loss in brightness may still occur since transmissive phosphors may reduce illumination efficiency.

In the delta-type PDP, a plurality of grouped triplets of red, green, and blue subpixels are formed between front and rear substrates. As in the stripe-type PDP, metallic scan and sustain electrodes may be formed on the front substrate, rather than a combination of metal and transparent electrodes, and address electrodes are formed on the rear substrate. Consequently, bright room contrast may improve by reducing external light reflection and brightness. However, as in the stripe-type PDP, an absolute brightness reduction may occur, thereby necessitating supplementary means to compensate for the brightness loss.

Accordingly, there is a need for a stripe-type and delta-type PDP configuration that improves contrast without unacceptably reducing brightness.

### SUMMARY OF THE INVENTION

The present invention provides a PDP that blocks reset light generated in unselected discharge cells to thereby improve contrast while preventing an unacceptable loss in brightness.

Additional features of the invention will be set forth in the description which follows, and in part will be apparent from the description, or may be learned by practice of the invention.

The present invention discloses a PDP including a first substrate, a plurality of discharge cells, and a first electrode and a second electrode formed on the first substrate along a second direction. The first electrode and the second electrode include a bus electrode formed along the second direction and a transparent electrode extending from the bus electrode in a direction toward a center of a discharge cell. The transparent electrode of the first electrode and the transparent electrode of the second electrode oppose one another with a gap therebetween in an area corresponding to the discharge cell. A transparent electrode comprises a light-blocking pattern.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partial exploded perspective view showing a PDP according to an exemplary embodiment of the present invention.

FIG. 2 is a partial sectional view taken along line A-A of FIG. 1.

FIG. 3 is a partial plan view showing discharge cell arrangement of the PDP of FIG. 1.

FIG. 4, FIG. 5, FIG. 6 and FIG. 7 are partial plan views showing light-blocking patterns according to exemplary embodiments of the present invention.

FIG. 8 and FIG. 9 are schematic views showing reset illumination brightness profiles of discharge cells provided in a stripe pattern and a delta pattern, respectively.

FIG. 10, FIG. 11 and FIG. 12 are partial plan views showing light-blocking patterns according to exemplary embodiments of the present invention.

### DETAILED DESCRIPTION OF THE ILLUSTRATED EMBODIMENTS

Exemplary embodiments of the present invention will now be described with reference to the drawings.

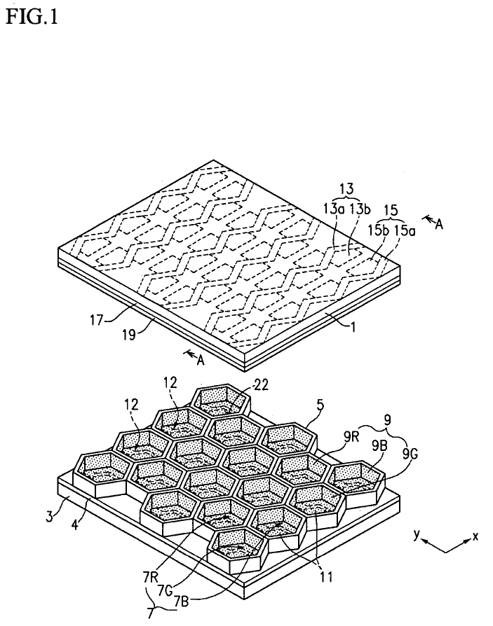

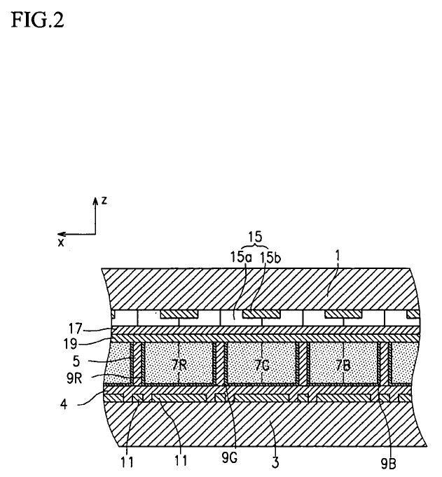

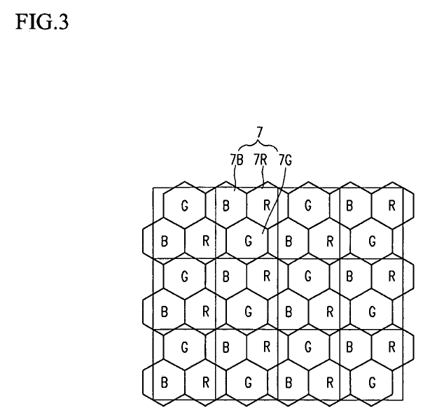

FIG. 1 is a partial exploded perspective view showing a PDP according to an exemplary embodiment of the present invention, FIG. 2 is a partial sectional view taken along line A-A of FIG. 1, and FIG. 3 is a partial plan view showing a discharge cell arrangement of the PDP of FIG. 1.

Referring to FIG. 1, FIG. 2 and FIG. 3, a delta-type PDP includes triplets of discharge cells 7R, 7G, 7B comprising one red discharge cell 7R, one green discharge cell 7G, and one blue discharge cell 7B, that are arranged in a triangular configuration to form pixels 7.

The PDP includes a first substrate 1 and a second substrate 3 provided opposing one another with a predetermined gap therebetween. Barrier ribs 5 may be formed in a pattern between the first substrate 1 and the second substrate 3 to define the pixels 7, which comprise three subpixels (i.e. a triplet of the discharge cells 7R, 7G, 7B). In this exemplary embodiment, the barrier ribs 5 define each discharge cell 7R, 7G, 7B as having a hexagonal planar shape.

A discharge gas needed for PDP operation may be filled in the discharge spaces. Further, red, green, and blue phosphor layers 9R, 9G, 9B comprising a phosphor layer 9 may be formed in the discharge cells 7R, 7G, 7B, respectively. The phosphor layers 9R, 9G, 9B may be deposited on a bottom surface of the discharge cells 7R, 7G, 7B, as well as on side walls of the barrier ribs 5 forming the discharge cells 7R, 7G, 7B.

Address electrodes 11 may be formed on a surface of the second substrate 3 opposing the first substrate 1 and along a first direction (i.e., direction y in the drawings). A first dielectric layer 4 may cover the address electrodes 11, which may be provided corresponding to the red, green, and blue discharge cells 7R, 7G, 7B.

First electrodes 13 and second electrodes 15, which function as discharge electrodes, may be formed on a surface of the first substrate 1 opposing the second substrate 3. The first and second electrodes 13, 15 may be formed along a second direction (i.e., direction x in the drawings), which is substantially perpendicular to the first direction. Further, a pair of a first electrode 13 and a second electrode 15 is provided corresponding to each row of the discharge cells 7R, 7G, 7B formed along direction y such that a pair of the first and second electrodes 13, 15 is formed opposing one another in each discharge cell 7R, 7G, 7B. The first and second electrodes 13, 15 operate during sustain discharge, and they are commonly referred to as display electrodes.

The first and second electrodes 13, 15 respectively include bus electrodes 13a, 15a, which may be formed above, and corresponding to the shape of, the barrier ribs 5 along direction x, and transparent electrodes 13b, 15b. The transparent electrodes 13b, 15b may protrude from the bus electrodes 13a, 15a along direction y toward centers of the discharge cells 7R, 7G, 7B such that a transparent electrode 13b and a transparent electrode 15b are provided opposing one another in an area corresponding to each discharge cell 7R, 7G, 7B.

The bus electrodes 13a, 15a may be made of a non-transparent material such as, for example, a metal, and they may be mounted over and corresponding to the shape of the barrier ribs 5 as described above. Consequently, this configuration provides the bus electrodes 13a, 15a with a bended zigzag shape as best shown in FIG. 1. In addition to being formed over the barrier ribs 5, the bus electrodes 13a, 15a may be as narrow as possible so they do not block visible light emitted from the discharge cells 7R, 7G, 7B. The transparent electrodes 13b, 15b are made of a transparent material such as, for example, indium tin oxide (ITO) to thereby ensure a high aperture ratio of the PDP.

A transparent second dielectric layer 17 may cover the first and second electrodes 13, 15, and a protection layer 19, which may be, for example, an MgO layer, may cover the second dielectric layer 17.

According to exemplary embodiments of the present invention, the transparent electrodes 13b, 15b may block undesired visible light, which may be generated from unselected discharge cells 7R, 7G, 7B, thereby enhancing contrast while acceptably maintaining brightness.

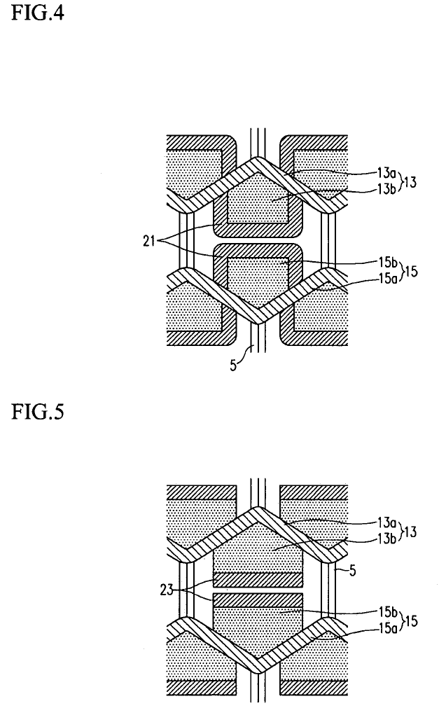

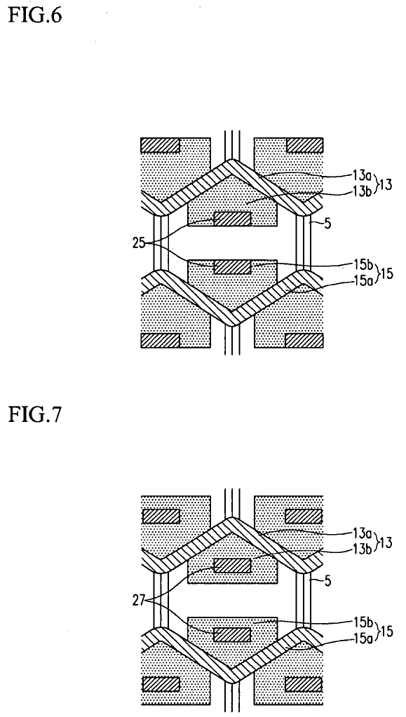

FIG. 4, FIG. 5, FIG. 6 and FIG. 7 are partial plan views showing the first substrate 1 having light-blocking patterns according to exemplary embodiments of the present is invention.

Referring to FIG. 4, FIG. 5, FIG. 6 and FIG. 7, light-blocking patterns 21, 23, 25 and 27 may be provided in the discharge cells to block reset light that may be generated in unselected discharge cells. The light-blocking patterns 21, 23, 25 and 27 may be formed on the transparent electrodes 13b, 15b, which are positioned corresponding to areas where reset light concentrates.

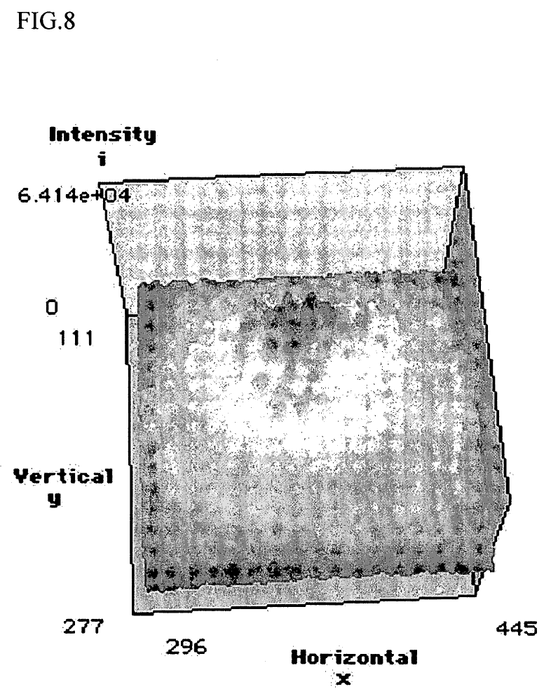

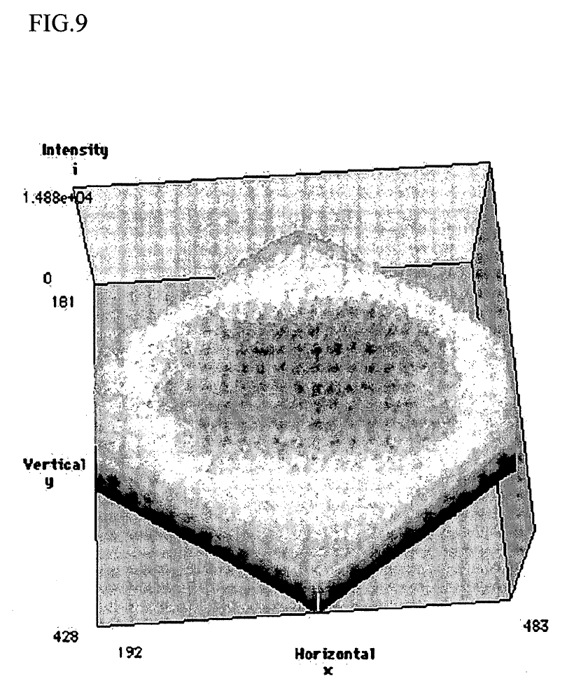

FIG. 8 and FIG. 9 are schematic views of reset illumination brightness profiles of discharge cells provided in a stripe pattern and a delta pattern, respectively. As FIG. 8 and FIG. 9 show, regardless of whether the discharge cells are provided in a stripe or delta pattern, reset light concentrates in the gaps between the first electrodes 13 and the second electrodes 15.

Accordingly, the light-blocking patterns 21, 23, 25 and 27, for example, may be formed adjacent to the gaps between transparent electrodes 13b, 15b. The light-blocking patterns 21 may be formed of the same layer as the bus electrodes 13a, 15a. In FIG. 4, the light-blocking patterns 21 are formed along the entire outer circumference of the transparent electrodes 13b, 15b. In FIG. 5, the stripe-shaped light-blocking patterns 23 are formed along distal edges of the transparent electrodes 13b, 15b, and in FIG. 6, stripe-shaped light-blocking patterns 25 are formed along predetermined portions of the distal edges of the transparent electrodes 13b, 15b. In FIG. 7, the light-blocking patterns 27 are formed at predetermined locations of the transparent electrodes 13b, 15b, that is, at a predetermined distance from their distal edges. As described above, the light-blocking patterns 21, 23, 25 and 27 block reset light generated in unselected discharge cells. The light-blocking patterns 21, 23, 25 and 27 function such that non-illuminated pixels are kept dark, which may make illuminated pixels appear brighter, thereby enhancing the PDP's contrast ratio.

The light-blocking patterns 21, 23, 25 and 27 may be made of a non-transparent material in order to block reset light illuminated from unselected discharge cells 7. Further, the light-blocking patterns 21, 23, 25 and 27 may be conductive, and they may be made of the same material as the bus electrodes 13a, 15a.

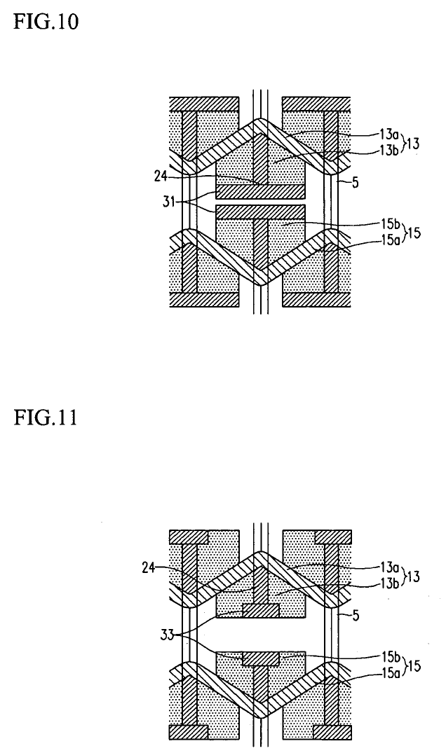

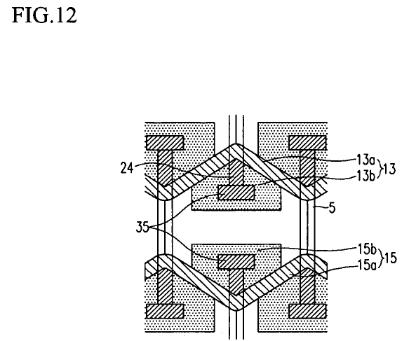

FIG. 10, FIG. 11 and FIG. 12 are partial plan views showing the first substrate 1 having light-blocking patterns 31, 33 and 35 according to exemplary embodiments of the present invention. FIG. 10, FIG. 11 and FIG. 12 correspond to FIG. 5, FIG. 6 and FIG. 7, respectively. The light-blocking patterns 31, 33 and 35 and the bus electrodes 13a, 15a are interconnected respectively through short bars 24. More specifically, the short bars 24 extend from the bends of the zigzag-shaped bus electrodes 13a, 15a to the corresponding light-blocking patterns 31, 33 and 35 to thereby interconnect these elements.

The light-blocking patterns 31, 33 and 35 may be deposited on the transparent electrodes 13a, 15a using a black pigment material. The black pigment material may prevent external light from significantly influencing the PDP's images, thereby enhancing the PDP's bright room contrast.

In a high-definition PDP, the number of the light-blocking patterns 31, 33 and 35 may be limited.

If the light-blocking patterns 21 and the bus electrodes 13a, 15a are interconnected using the configuration shown in FIG. 4, or through the short bars 24 as shown in FIG. 10, FIG. 11 and FIG. 12, the combination of the light-blocking patterns 21, 31, 33 and 35 and the bus electrodes 13a, 15a performs the function of the bus electrodes 13a, 15a. Accordingly, it is possible to reduce the width of the bus electrodes 13a, 15a. In this case, the light-blocking patterns 21, 31, 33 and 35 the bus electrodes 13a, 15a may have a substantially equal width.

For example, when the light-blocking patterns 21, 31, 33 and 35 are 40 μm wide, and the bus electrodes 13a, 15a are also 40 μm wide, a conductivity of the bus electrodes 13a, 15a may be as if the bus electrodes 13a, 15a were formed 80 μm wide. Further, forming equally wide light-blocking patterns 21, 31, 33 and 35 and bus electrodes 13a, 15a may prevent problems such as electrode pattern breaks, which may be caused by thermal stress balance.

The bus electrodes 13a, 15a and the light-blocking patterns 21, 31, 33 and 35 may be formed to be about 30 μm to 70 μm wide. If made less than 30 μm wide, the bus electrodes 13a, 15a may break. If made wider than 70 μm, they may block part of the light emitted from the illumination regions.

Referring to FIG. 5, FIG. 6 and FIG. 7, when the light-blocking patterns 23, 25 and 27 and the bus electrodes 13a, 15a are not interconnected, the light-blocking patterns 23, 25 and 27 may enhance the conductivity of the transparent electrodes 13b, 15b. In this case, the bus electrodes 13a, 15a (to which a drive voltage is applied) may be made wider than the light-blocking patterns 23, 25 and 27. For example, if the bus electrodes 13a, 15a are formed to be 80μm wide, the light-blocking patterns 23, 25 and 27 may be formed to be up to 20 μm wide.

With this configuration, the bus electrodes 13a, 15a may be formed to be about 70 μm to 90 μm wide, and the light-blocking patterns 23, 25 and 27 may be formed to be about 20 μm to 50 μm. If the bus electrodes 13a, 15a are less than 70 μm wide, the bus electrodes 13a, 15a may break. On the other hand, if they are wider than 90 μm, they may block part of the light emitted from the illumination regions.

While the exemplary embodiments of the present invention were described in relation to a delta-type PDP, the present invention is not limited to this structure. For example, the above-described configuration may be applied to a stripe-type PDP in which the barrier ribs define the subpixels such that adjacent subpixels (i.e., adjacent along the direction the address electrodes 11 are formed) share phosphor layers of the same color.

In the PDP of the present invention described above, the light-blocking patterns are formed on the transparent electrodes to block reset light emitted from unselected discharge cells. As a result, contrast is improved while preventing an unacceptable reduction in brightness.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate;
a plurality of discharge cells; and
a first electrode and a second electrode formed on the first substrate along a first direction,
wherein the first electrode and the second electrode include a bus electrode formed along the first direction and a transparent electrode extending from the bus electrode in a direction toward a center of a discharge cell,
wherein the transparent electrode of the first electrode and the transparent electrode of the second electrode oppose one another with a gap therebetween in an area corresponding to the discharge cell, and
wherein a transparent electrode comprises a light-blocking pattern.

2. The PDP of claim 1, wherein the light-blocking pattern is conductive.

3. The PDP of claim 1, wherein the light-blocking pattern is formed adjacent to the gap.

4. The PDP of claim 1, wherein the light-blocking pattern is formed along an outer circumference of the transparent electrode.

5. The PDP of claim 1, wherein the light-blocking pattern has a stripe shape and is formed along a distal edge of the transparent electrode.

6. The PDP of claim 1, wherein the light-blocking pattern is formed along a portion of a distal edge of the transparent electrode.

7. The PDP of claim 1, wherein the light-blocking pattern is formed at a predetermined distance from a distal edge of the transparent electrode.

8. The PDP of claim 1, wherein the light-blocking pattern is connected to a bus electrode.

9. The PDP of claim 8, wherein the light-blocking pattern and the bus electrode are substantially equally wide.

10. The PDP of claim 9, wherein the light-blocking pattern is about 30 μm to 70 μm wide.

11. The PDP of claim 1, wherein the light-blocking pattern is separate from a bus electrode, and the bus electrode is wider than the light blocking pattern.

12. The PDP of claim 11, wherein the bus electrode is about 70 μm to 90 μm wide, and the light-blocking pattern is about 20 μm to 50 μm wide.

13. The PDP of claim 1, further comprising:
a plurality of barrier ribs,
wherein the barrier ribs define the discharge cells such that discharge cells forming a pixel are arranged in a triangular configuration.

14. The PDP of claim 13, wherein each discharge cell has a hexagonal planar shape, and a bus electrode is formed along a barrier rib and has a bended zigzag-shape.

15. The PDP of claim 14, further comprising a short bar that extends from a bend of the bus electrode to the light-blocking pattern.

16. The PDP of claim 1, further comprising:
an address electrode formed on a second substrate facing the first substrate; and
a plurality of barrier ribs between the first substrate and the second substrate,
wherein the barrier ribs define the discharge cells such that adjacent discharge cells along a direction the address electrode extends have the same color phosphor layer.

17. The PDP of claim 1, wherein the light-blocking pattern is formed on the transparent electrode and of the same layer as a bus electrode.

18. The PDP of claim 1, wherein the light-blocking pattern is made of the same material as a bus electrode.

19. The PDP of claim 1, wherein the light-blocking pattern includes a black pigment material.
